(19) United States
(12) Patent Application Publication
(10) Pub. No.: US 2022/0415139 A1
(43) Pub. Date: Dec. 29, 2022

(54) UNMANNED PRIVATE VIEWING SYSTEM

(71) Applicant: TAISHO SKY BUILDING, INC., Tokyo (JP)

(72) Inventor: Kazuhara Ishida, Tokyo (JP)

(21) Appl. No.: 17/822,798

(22) Filed: Aug. 28, 2022

Related U.S. Application Data
(63) Continuation of application No. PCT/JP2020/008444, filed on Feb. 28, 2020.

(51) Int. Cl. G08B 5/22; G08B 13/196; G06Q 30/00; G06Q 10/02; G06Q 50/16; G05D 1/00

(52) U.S. Cl. CPC G08B 5/22; G08B 13/19613; G06Q 30/016; G06Q 10/02; G06Q 50/163; G05D 1/0038; G05D 2201/0207

(57) ABSTRACT

An unmanned preview system that enables an unmanned preview of a building without requiring presence of an agent and can suppress damage or the like inside the building, wherein an unmanned preview system includes: a preview robot that is configured to be placeable inside the building and has portability; and a management device that is connected to the preview robot via a communication line and manages the preview robot. The preview robot includes an abnormality notifier that notifies the management device of an abnormality via the communication line when the abnormality having occurred inside the building is detected. The management device includes an abnormality annunciator that announces the abnormality to an administrator when it is notified of the abnormality by the abnormality notifier.

### RELATED APPLICATIONS

The present application is a continuation of International Patent Application No. PCT/JP2020/008444, filed Feb. 28, 2020, which is hereby incorporated by reference in its entirety.

### TECHNICAL FIELD

This disclosure relates to an unmanned preview system that allows a previewer to preview an inside of a building.

### BACKGROUND

Conventionally, in real estate brokerage business, a system that allows free preview inside the building has been proposed. For example, in a conventional real estate brokerage business support system, a preview robot is provided in a real estate property (the building), and information such as a state inside the property and sounds inside the property obtained by the preview robot is transmitted to a customer terminal, so that it is possible to preview the building unattended without requiring presence of an agent.

### SUMMARY

In conventional systems, although the building can be previewed unattended, there is a problem that it is not possible to meet a request of an applicant who wants to decide whether to move in by actually previewing the inside of the building.

On the other hand, when actually allowing the applicant to preview the inside of the building in order to meet the request of the applicant, it is necessary to have the presence of the agent in order to suppress damage or the like inside the building.

An object of the present disclosure is to provide an unmanned preview system that enables an unmanned preview of the building without requiring the presence of the agent and can suppress the damage or the like inside the building.

The unmanned preview system of the present disclosure includes: a transportable device that is configured to be placeable inside a building and has portability; and a management device that is connected to the transportable device via a communication line and manages the transportable device, and the transportable device includes a transportable device side control unit that controls the transportable device, the transportable device side control unit includes an abnormality notifier that notifies the management device of an abnormality via the communication line when the abnormality having occurred inside the building is detected, the management device includes a management device side control unit that controls the management device, and the management device side control unit includes an abnormality annunciator that announces the abnormality to an administrator when it is notified of the abnormality by the abnormality notifier.

With such a configuration, since the transportable device is configured to be placeable inside the building and has portability, it can be placed in the building desired for the preview before the preview, and when a tenant contract is concluded, the transportable device can be easily removed. Further, the transportable device side control unit includes the abnormality notifier that notifies the management device of the abnormality via the communication line when the abnormality having occurred inside the building is detected, and the management device side control unit includes the abnormality annunciator that announces the abnormality to the administrator when it is notified of the abnormality by the abnormality notifier, so that the manager can easily grasp the abnormality such as damage inside the building even when the building is previewed without the presence of the agent. Therefore, according to the unmanned preview system of the present disclosure, it is possible to preview the building unattended without requiring the presence of the agent, and to suppress the damage or the like inside the building.

In the present disclosure, it is preferred that the transportable device is connected to a locking device of the building via a communication line, and the transportable device side control unit includes a locking device determiner that determines whether the locking device has been normally unlocked, and detects the abnormality having occurred inside the building when it has determined that the locking device has not been normally unlocked.

With such a configuration, the transportable device side control unit includes the locking device determiner that determines whether the locking device has been normally unlocked, and detects the abnormality having occurred inside the building when it has determined that the locking device has not been normally unlocked, so that for example, unlike the previewer who can unlock the locking device normally, that is, the previewer authorized by the administrator, intrusion of an unauthorized person using an illegal means such as picking can be detected as the abnormality by the locking device determiner, and safety of the building can be improved.

In the present disclosure, it is preferred that the transportable device includes a customer service unit that serves a previewer of the building, and the transportable device side control unit includes a customer service executor that executes customer service by the customer service unit when the locking device determiner determines that the locking device is normally unlocked.

With such a configuration, the transportable device side control unit includes the customer service executor that executes customer service by the customer service unit when the locking device determiner determines that the locking device is normally unlocked, so that it is possible to execute customer service by the customer service unit to the previewer who can unlock the locking device normally, that is, the previewer authorized by the administrator. Here, examples of contents of the customer service by the customer service unit include that selling points of the building are explained to the previewer, the previewer is guided to preview the inside of the building, and lighting and an air conditioner installed in the building are operated.

In the present disclosure, it is preferred that the transportable device includes an image capturing unit that captures an image of an inside of the building, and the transportable device side control unit includes: a storage that stores a sample of a normal behavior pattern of a previewer of the building; a behavior pattern obtainer that obtains the behavior pattern of the previewer of the building on the basis of the image captured by the image capturing unit; and a behavior pattern determiner that compares a sample of a behavior pattern stored in the storage unit with the behavior pattern obtained by the behavior pattern obtainer and determines whether there is a difference, and detects the abnormality having occurred inside the building when it has determined that there is the difference.

With such a configuration, the transportable device side control unit includes the behavior pattern determiner that compares the sample of the normal behavior pattern of the previewer of the building with the behavior pattern obtained by the behavior pattern obtainer and determines whether there is a difference, and detects the abnormality having occurred inside the building when it has determined that there is the difference, so that for example, by memorizing in the storage as the normal behavior pattern the behavior pattern conforming to a normal preview such as looking around the inside of the building, it is possible to detect by the behavior pattern determiner, as the abnormality, an intruder with a suspicious behavior pattern such as looking for the inside of the building, and to improve the safety of the building.

In the present disclosure, it is preferred that the transportable device includes an image capturing unit that captures an image of an inside of the building, and the transportable device side control unit includes: a storage that stores a sample of an abnormal behavior pattern of a previewer of the building; a behavior pattern obtainer that obtains the behavior pattern of the previewer of the building on the basis of the image captured by the image capturing unit; and a behavior pattern determiner that compares a sample of a behavior pattern stored in the storage unit with the behavior pattern obtained by the behavior pattern obtainer and determines whether the sample of a behavior pattern and the obtained behavior pattern match, and detects the abnormality having occurred inside the building when it has determined that the sample of a behavior pattern and the obtained behavior pattern match.

With such a configuration, the transportable device side control unit includes the behavior pattern determiner that compares the sample of the abnormal behavior pattern of the previewer of the building with the behavior pattern obtained by the behavior pattern obtainer and determines whether the sample of a behavior pattern and the obtained behavior pattern match, and detects the abnormality having occurred inside the building when it has determined that the sample of a behavior pattern and the obtained behavior pattern match, so that for example, by memorizing in the storage as the abnormal behavior pattern the suspicious behavior pattern such as looking for the inside of the building, it is possible to detect the intruder with the suspicious behavior pattern as the abnormality by the behavior pattern determiner, and to improve the safety of the building.

In the present disclosure, it is preferred that the management device side control unit includes: a reservation manager that manages reservation information including preview start time and preview end time set by reservation; a command generator that generates a command to the transportable device on the basis of the reservation information; and a command transmitter that transmits the command to the transportable device via the communication line, and the transportable device side control unit includes: a command receiver that receives the command from the command transmitter; and a command executor that executes a predetermined operation on the basis of the command received by the command receiver.

With such a configuration, the transportable device side control unit includes: the command receiver that receives the command from the command transmitter; and the command executor that executes the predetermined operation on the basis of the command received by the command receiver, so that it is possible to reach out to the previewer who is looking around the inside of the building by executing an operation based on an appropriate command. Therefore, for example, the transportable device can suppress time excess of the preview by announcing the preview end time to the previewer, set free time until reservation of a next previewer to be short, and improve efficiency of previewing the building.

In the present disclosure, it is preferred that the command generator generates an announcement command to announce the preview end time on the basis of the reservation information, and the command executor announces the preview end time to the previewer on the basis of the announcement command.

With such a configuration, since the command executor announces the preview end time to the previewer on the basis of the announcement command, the transportable device can suppress the time excess of the preview by announcing the preview end time to the previewer, set free time until the reservation of the next previewer to be short, and improve the efficiency of previewing the building.

In the present disclosure, it is preferred that the reservation manager manages the reservation information including a reservation status after the preview end time, the command generator generates an extension command to announce whether a preview time can be extended according to the reservation status on the basis of the reservation information, and the command executor announces to the previewer whether the preview time can be extended on the basis of the extension command.

With such a configuration, since the command executor announces to the previewer whether the preview time can be extended on the basis of the extension command, when there is free time in the reservation after the preview end time, it is possible to announce to the previewer that the preview time can be extended. In addition, when there is no free time in the reservation after the preview end time, it is possible to announce to the previewer that the preview time cannot be extended.

In the present disclosure, it is preferred that the transportable device includes an input receiving unit that receives an input of an application for extension by the previewer, the transportable device side control unit includes an application transmitter that transmits the application for extension to the management device via the communication line when the input of the application for extension is received by the input receiving unit, the management device side control unit includes an application receiver that receives the application for extension transmitted from the application transmitter, and the reservation manager changes the preview end time and updates the reservation information on the basis of the application for extension received by the application receiver.

With such a configuration, the management device side control unit includes the application receiver that receives the application for extension transmitted from the application transmitter, and the reservation manager changes the preview end time and updates the reservation information on the basis of the application for extension received by the application receiver, so that an extension processing can be executed on the basis of the application for extension by the previewer.

In the present disclosure, it is preferred that the transportable device includes a presence detection unit that detects presence of the previewer inside the building, the transportable device side control unit includes a presence notifier that notifies the management device of the presence of the previewer via the communication line when the presence detection unit detects the presence of the previewer, the management device side control unit includes a presence manager that manages presence information of the previewer notified by the presence notifier, the command generator generates a warning command to announce a warning to the previewer when the previewer is present even after the preview end time on the basis of the reservation information and the presence information, and the command executor announces to the previewer that the preview end time has passed on the basis of the warning command.

With such a configuration, the command generator generates the warning command to announce the warning to the previewer when the previewer is present even after the preview end time on the basis of the reservation information and the presence information, and the command executor announces to the previewer that the preview end time has passed on the basis of the warning command, so that it is possible to reliably announce the time excess of the preview to the previewer.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of an unmanned preview system according to an embodiment of the present invention.

FIG. 2 is a functional block diagram illustrating a schematic configuration of the unmanned preview system.

FIG. 3 is a flowchart illustrating an operation of the unmanned preview system.

FIG. 4 is a flowchart illustrating a behavior pattern determination processing.

FIG. 5 is a flowchart illustrating an extension announcement processing.

FIG. 6 is a flowchart illustrating a warning processing.

### DETAILED DESCRIPTION

Hereinafter, implementations of the present disclosure will be described with reference to the drawings.

Hereinafter, an embodiment of the present invention will be described with reference to the drawings.

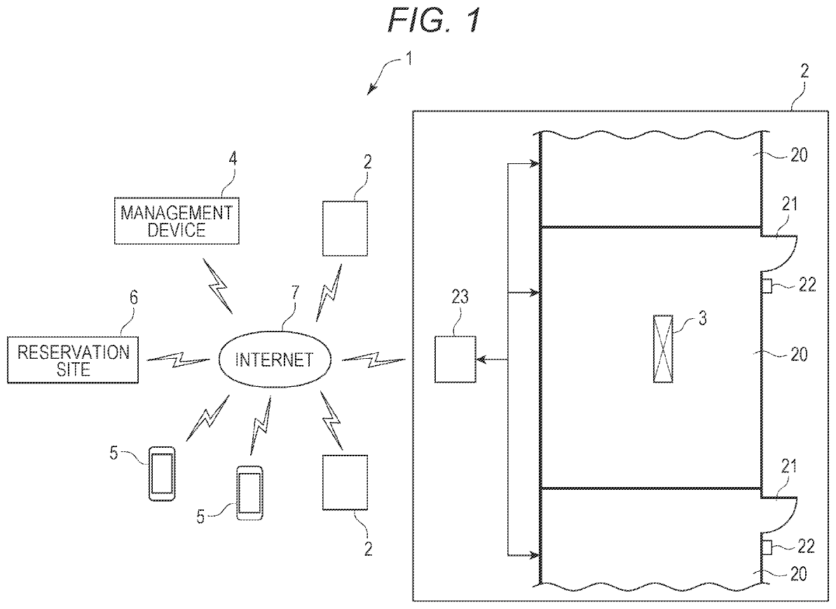

FIG. 1 is a schematic configuration diagram of an unmanned preview system according to the embodiment of the present invention.

As illustrated in FIG. 1, an unmanned preview system 1 includes a preview robot 3 placed inside a building 2, a management device 4 for managing the preview robot 3, a terminal device 5 such as a mobile phone, a smartphone, or a personal computer possessed by a previewer who wishes to preview the building 2, and a reservation site 6 for reserving a preview of the building 2. The building 2, the preview robot 3, the management device 4, the terminal device 5, and the reservation site 6 are connected to each other so as to be able to communicate with each other via the Internet 7 that is a public network as a communication line.

The building 2 includes a plurality of rooms 20, and each room 20 includes a doorway 21 and a locking device 22 for locking and unlocking the doorway 21. The locking device 22 can be unlocked by an authentication key such as a password or a bar code issued from the management device 4 to the terminal device 5 of the previewer. The authentication key is randomly changed each time it is used, and the previewer who makes a reservation for that time can unlock the locking device 22 by using a unique authentication key. Each room 20 includes a communication terminal device 23 such as a modem or a router connected via a local area network (LAN). The communication terminal device 23 is connected to the management device 4 via the Internet 7.

The preview robot 3 is a transportable device that is configured to be placeable inside the building 2 and has portability. The preview robot 3 is carried into the building 2 by a real estate brokerage agent who manages the building 2 when the building 2 is previewed. Further, when a tenant contract is concluded for the building 2, the preview robot 3 is removed from inside the building 2 by the real estate brokerage agent who manages the building 2.

The previewer can access the reservation site 6 via the Internet 7 using the terminal device 5, search for the room 20 desired for preview, and make a reservation for the preview by specifying a usage time. Upon receiving the reservation from the previewer, the reservation site 6 transmits reservation information including the room 20 for which the reservation has been confirmed and reservation time to the management device 4.

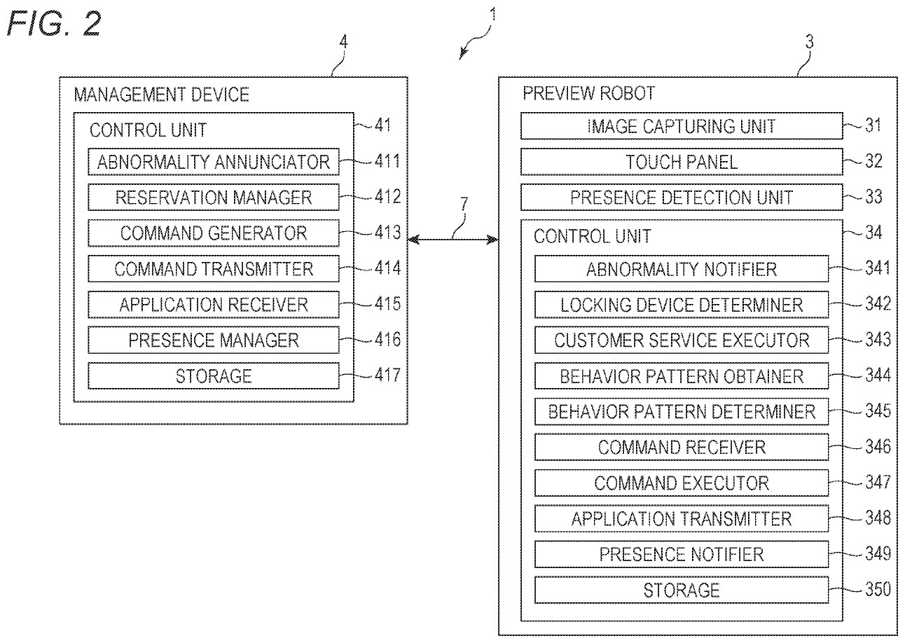

FIG. 2 is a functional block diagram illustrating a schematic configuration of the unmanned preview system.

As illustrated in FIG. 2, the preview robot 3 includes an image capturing unit 31, a touch panel 32, a presence detection unit 33, and a control unit 34 as a transportable device side control unit.

The image capturing unit 31 captures an image of an inside of the room 20. As the image capturing unit 31, for example, a charge coupled device (CCD) camera or the like can be employed.

The touch panel 32 receives an input of information according to an operation of the previewer and provides predetermined information as the image to the previewer.

The presence detection unit 33 detects presence of the previewer inside the room 20. As the presence detection unit 33, for example, a motion sensor or the like can be employed, and in addition, the presence of the previewer may be detected by using the image captured by the image capturing unit 31.

The control unit 34 includes a central processing unit (CPU), a memory, and the like, and executes an information processing according to a predetermined program stored in the memory. The control unit 34 includes an abnormality notifier 341, a locking device determiner 342, a customer service executor 343, a behavior pattern obtainer 344, a behavior pattern determiner 345, a command receiver 346, a command executor 347, an application transmitter 348, a presence notifier 349, and a storage 350.

Here, the storage 350 stores in advance a plurality of samples of normal behavior pattern of the previewer of the room 20. Specifically, the storage 350 stores as the normal behavior pattern a behavior pattern conforming to a normal preview such as looking around the inside of the building.

Note that in the present embodiment, the storage 350 includes a memory of the control unit 34, but may include a hard disk drive (HDD), a network attached storage (NAS), or the like, and may include a cloud service.

Further, although functions of the control unit 34 are executed according to the program stored in the storage 350, each function may be implemented by an independent device or may be implemented by cloud computing.

Upon detecting an abnormality having occurred inside the room 20, the abnormality notifier 341 notifies the management device 4 of the abnormality via the Internet 7. The locking device determiner 342 determines whether the locking device 22 has been normally unlocked, and detects the abnormality having occurred inside the room 20 when it has determined that the locking device 22 has not been normally unlocked.

When the locking device determiner 342 determines that the locking device 22 is normally unlocked, the customer service executor 343 executes customer service using the touch panel 32. Specifically, the control unit 34 displays selling points of the room 20 on a display screen of the touch panel 32, and starts explanation to the previewer.

In this way, the touch panel 32 functions as a customer service unit that serves to the previewer of the room 20.

Note that in the present embodiment, the touch panel 32 is employed as the customer service unit, but for example, a moving unit capable of freely moving in the room 20 may be attached to the preview robot 3 to guide the previewer to look around the inside of the room 20, and lighting and an air conditioner installed in the room 20 may be connected via a communication line to be automatically operated. In conclusion, any customer service unit may be employed as long as it can serve the previewer of the building.

The behavior pattern obtainer 344 obtains the behavior pattern of the previewer of the room 20 on the basis of the image captured by the image capturing unit 31.

The behavior pattern determiner 345 compares the plurality of samples of the behavior pattern stored in the storage 350 with the behavior pattern obtained by the behavior pattern obtainer 344, determines whether the samples of a behavior pattern and the obtained behavior pattern differ, and if it has determined that the samples of a behavior pattern and the obtained behavior pattern differ, it detects the abnormality generated inside the room 20.

As described above, in the present embodiment, when the locking device determiner 342 detects the abnormality having occurred inside the room 20, or when the behavior pattern determiner 345 detects the abnormality having occurred inside the room 20, the abnormality notifier 341 notifies the management device 4 of the abnormality via the Internet 7.

On the other hand, for example, a sound collecting unit such as a microphone may collect sounds inside the room 20, and it may be determined whether damage or the like inside the room 20 has occurred on the basis of the collected sounds, and when it is determined that the damage or the like inside the room 20 has occurred, the abnormality having occurred inside the room 20 may be detected. In conclusion, when the abnormality having occurred inside the building is detected, the abnormality notifier is only required to be able to notify the management device of the abnormality via the communication line.

The command receiver 346 receives a command from the management device 4.

The command executor 347 executes a predetermined operation on the basis of the command received by the command receiver 346. The predetermined operation will be described in detail below.

The application transmitter 348 transmits an application for extension of a preview time by the previewer to the management device 4. Specifically, upon receiving the input of the application for extension by the previewer via the touch panel 32, the application transmitter 348 transmits the application for extension to the management device 4 via the Internet 7.

When the presence detection unit 33 detects the presence of the previewer, the presence notifier 349 notifies the management device 4 of the presence of the previewer via the Internet 7.

The management device 4 includes a control unit 41 as a management device side control unit.

The control unit 41 includes the CPU, the memory, and the like, and executes an information processing according to the predetermined program stored in the memory. The control unit 41 includes an abnormality annunciator 411, a reservation manager 412, a command generator 413, a command transmitter 414, an application receiver 415, a presence manager 416, and a storage 417.

The abnormality annunciator 411 announces the abnormality to the administrator when it is notified of the abnormality by the abnormality notifier 341. Specifically, the abnormality annunciator 411 announces the abnormality to the administrator via a display device (not illustrated) connected to the management device 4.

The reservation manager 412 causes the storage 417 to store the reservation information including preview start time and preview end time set by the reservation, and manages the reservation information.

The command generator 413 generates a command to the preview robot 3 on the basis of the reservation information. Specifically, the command generator 413 generates various commands such as an announcement command to announce the preview end time, an extension command to announce whether the preview time can be extended according to a reservation status, and a warning command to announce a warning to the previewer when the previewer is present even after the preview end time.

The command transmitter 414 transmits the command to the preview robot 3 via the Internet 7.

The application receiver 415 receives the application for extension transmitted from the application transmitter 348 of the preview robot 3. Then, the reservation manager 412 changes the preview end time and updates the reservation information, on the basis of the application for extension received by the application receiver 415.

The presence manager 416 causes the storage 417 to store presence information of the previewer notified by the presence notifier 349, and manages the presence information.

Note that the storage 417 includes the memory of the control unit 41, but may include the hard disk drive (HDD), the network attached storage (NAS), or the like, and may include the cloud service.

Further, although functions of the control unit 41 are executed according to the program stored in the storage 417, each function may be implemented by the independent device or may be implemented by cloud computing.

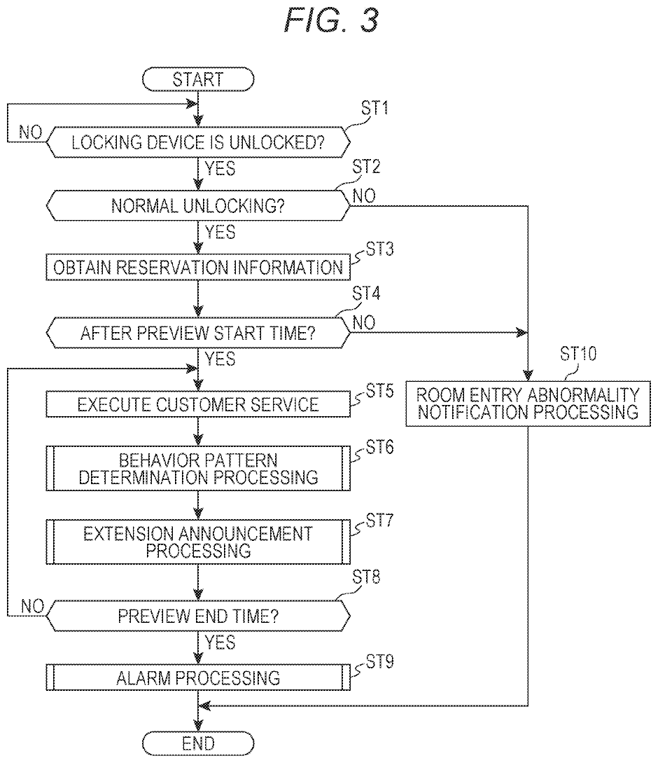

FIG. 3 is a flowchart illustrating the operation of the unmanned preview system.

The unmanned preview system 1 executes the processing of Steps ST1 to 10 as illustrated in FIG. 3 according to the predetermined program stored in the memory.

Note that in the present embodiment, the operation of the preview robot 3 and the operation of the management device 4 are collectively referred to as the operation of the unmanned preview system 1, and this will be described using a common flowchart.

First, the locking device determiner 342 of the preview robot 3 determines whether the locking device 22 has been unlocked (Step ST1).

If it is determined in Step ST1 that the locking device 22 is not unlocked, the locking device determiner 342 repeatedly executes the processing in Step ST1.

On the other hand, when it is determined in Step ST1 that the locking device 22 has been unlocked, the locking device determiner 342 determines whether the locking device 22 has been normally unlocked (Step ST2).

When it is determined in Step ST2 that the locking device 22 is not normally unlocked, the control unit 34 executes a room entry abnormality notification processing in Step ST10 to be described below. The room entry abnormality notification processing in Step ST10 will be described in detail below.

On the other hand, when it is determined in Step ST2 that the locking device 22 has been normally unlocked, the locking device determiner 342 makes an inquiry to the management device 4 via the Internet 7, and obtains the reservation information from the storage 417 of the management device 4 (Step ST3).

Here, the reservation information stored in the storage 417 of the management device 4 includes the preview start time and the preview end time set by reservation of the previewer, and is stored and managed in the storage 417 by the reservation manager 412.

After obtaining the reservation information from the storage 417 of the management device 4, the control unit 34 determines whether a time when the locking device 22 is normally unlocked is after the preview start time on the basis of the reservation information (Step ST4).

If it is determined in Step ST4 that it is not after the preview start time, the control unit 34 executes the room entry abnormality notification processing in Step ST10 to be described below. The room entry abnormality notification processing in Step ST10 will be described in detail below.

On the other hand, when it is determined in Step ST4 that it is after the preview start time, that is, when the locking device determiner 342 determines that the locking device 22 is normally unlocked after the preview start time, the customer service executor 343 executes customer service by the touch panel 32 (Step ST5: customer service execution processing). Specifically, the control unit 34 displays the selling points of the room 20 on the display screen of the touch panel 32, and starts explaining to the previewer.

Further, the control unit 34 executes a behavior pattern determination processing in Step ST6 after starting the customer service execution processing, and executes an extension announcement processing in Step ST7.

Note that the behavior pattern determination processing in Step ST6 and the extension announcement processing in Step ST7 will be described in detail below.

After executing the extension announcement processing in Step ST7, the control unit 34 determines whether the current time is after the preview end time (Step ST8).

If it is determined in Step ST8 that it is not after the preview end time, the control unit 34 repeatedly executes the processing after Step ST5 described above.

On the other hand, if it is determined in Step ST8 that it is after the preview end time, the control unit 34 executes an alarm processing in Step ST9.

Note that the alarm processing in Step ST9 will be described in detail below.

Further, when it is determined in Step ST2 that the locking device 22 is not normally unlocked, or when it is determined in Step ST4 that it is not after the preview start time, the control unit 34 executes the room entry abnormality notification processing in Step ST10 as described above. In other words, when the control unit 34 detects the abnormality having occurred inside the room 20, the control unit 34 executes the room entry abnormality notification processing in Step ST10.

In the room entry abnormality notification processing in Step ST10, the abnormality notifier 341 notifies the management device 4 of the abnormality via the Internet 7.

Then, the abnormality annunciator 411 of the management device 4 announces the abnormality to the administrator when it is notified of the abnormality by the abnormality notifier 341. Specifically, the abnormality annunciator 411 announces the abnormality to the administrator via the display device (not illustrated) connected to the management device 4.

Behavior Pattern Determination Processing

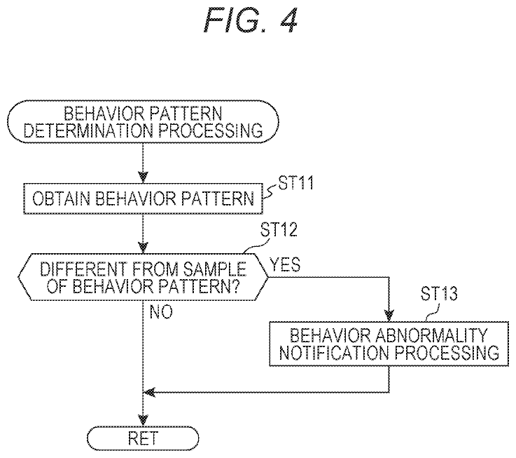

FIG. 4 is a flowchart illustrating the behavior pattern determination processing.

The control unit 34 executes the behavior pattern determination processing of Steps ST11 to ST13 as illustrated in FIG. 4 according to the predetermined program stored in the memory.

In the behavior pattern determination processing, the behavior pattern obtainer 344 obtains the behavior pattern of the previewer in the room 20 on the basis of the image captured by the image capturing unit 31 (Step ST11).

After obtaining the behavior pattern of the previewer in the room 20 in Step ST11, the behavior pattern determiner 345 compares the plurality of samples of the behavior pattern stored in the storage 350 with the behavior pattern obtained by the behavior pattern obtainer 344, and determines whether the samples of a behavior pattern and the obtained behavior pattern differ (Step ST12).

If it is determined that the samples of a behavior pattern and the obtained behavior pattern do not differ in Step ST12, the control unit 34 ends the behavior pattern determination processing.

On the other hand, if it is determined that the samples of a behavior pattern and the obtained behavior pattern differ in Step ST12, the control unit 34 executes a behavior abnormality notification processing in Step ST13. In other words, when the control unit 34 detects the abnormality having occurred inside the room 20, the control unit 34 executes the behavior abnormality notification processing in Step ST13.

In the behavior abnormality notification processing in Step ST13, the abnormality notifier 341 notifies the management device 4 of the abnormality via the Internet 7.

Then, the abnormality annunciator 411 of the management device 4 announces the abnormality to the administrator when it is notified of the abnormality by the abnormality notifier 341. Specifically, the abnormality annunciator 411 announces the abnormality to the administrator via the display device (not illustrated) connected to the management device 4.

Extension Announcement Processing

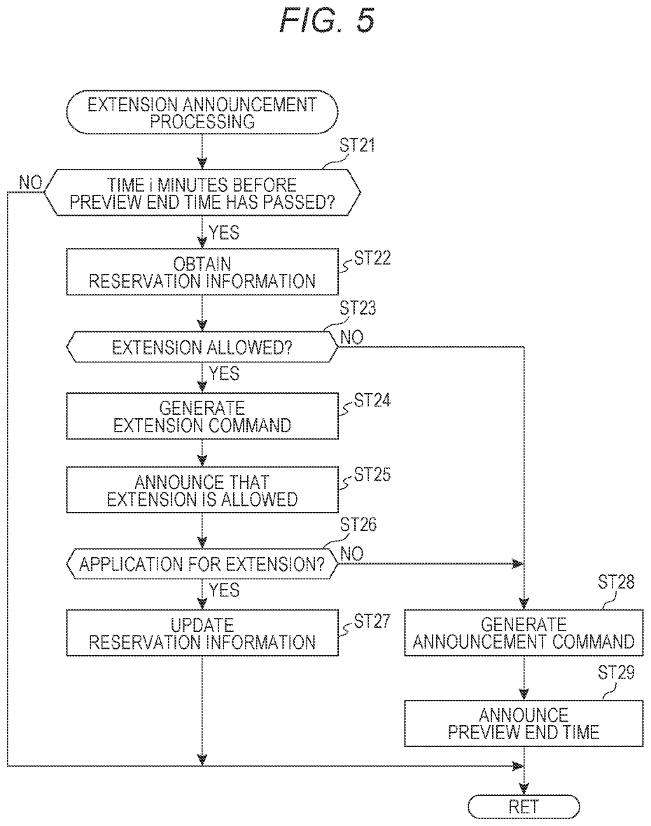

FIG. 5 is a flowchart illustrating the extension announcement processing.

The control unit 41 of the management device 4 executes the extension announcement processing of Steps ST21 to ST29 as illustrated in FIG. 5 according to the predetermined program stored in the memory.

In the extension announcement processing, the control unit 41 determines whether a predetermined time i minutes (a time set by the administrator, for example, 10 minutes) before the preview end time has passed (Step ST21).

When it is determined that the time has passed in Step ST21, the control unit 41 obtains the reservation information from the storage 417 (Step ST22).

After obtaining the reservation information from the storage 417, the control unit 41 checks whether there is free time for a predetermined time (for example, 30 minutes) or more after the preview end time on the basis of the reservation information, and determines whether the preview time can be extended (Step ST23).

When it is determined that the preview time can be extended in Step ST23, the command generator 413 generates the command to the preview robot 3 on the basis of the reservation information. Specifically, the command generator 413 generates the extension command for announcing whether the preview time can be extended according to the reservation status (Step ST24). More specifically, the command generator 413 generates, as the extension command, availability information that “the preview time can be extended” as the information that the preview time can be extended, and extension time information that “it can be extended up to 2 hours” as a time that can be extended.

Then, the command transmitter 414 transmits the extension command to the preview robot 3 via the Internet 7.

Thereafter, the command receiver 346 of the preview robot 3 receives the extension command from the management device 4.

Then, the command executor 347 executes the predetermined operation on the basis of the extension command received by the command receiver 346. Specifically, the command executor 347 displays information that “the preview time can be extended”, “it can be extended up to 2 hours”, and “please apply for extension from the screen if desired” on the display screen of the touch panel 32, to announce to the previewer (Step ST25).

After announcing to the previewer that the preview time can be extended, the control unit 34 determines whether the input of the application for extension by the previewer has been received via the touch panel 32 (Step ST26).

If it is determined in Step ST26 that the input of the application for extension by the previewer has been received, the application transmitter 348 transmits the application for the extension of the preview time by the previewer to the management device 4. In other words, when the application transmitter 348 receives the input of the application for extension by the previewer via the touch panel 32, the application transmitter 348 transmits the application for extension to the management device 4 via the Internet 7. Therefore, in the present embodiment, the touch panel 32 functions as the input receiving unit for receiving the input of the application for extension by the previewer.

When the application transmitter 348 transmits the application for extension, the application receiver 415 of the management device 4 receives the application for extension transmitted from the application transmitter 348 of the preview robot 3. Then, the reservation manager 412 changes the preview end time and updates the reservation information, on the basis of the application for extension received by the application receiver 415 (Step ST27). Thereafter, the preview robot 3 and the management device 4 end the extension announcement processing.

On the other hand, when it is determined in Step ST26 that the input of the application for extension by the previewer is not received (when the previewer selects not to extend the preview time, when an operation of the touch panel 32 is not detected within a predetermined time, or the like), the application transmitter 348 transmits an application for non-extension to the management device 4 instead of the application for extension of the preview time by the previewer.

When the application for non-extension is transmitted by the application transmitter 348, the application receiver 415 of the management device 4 receives the application for non-extension transmitted from the application transmitter 348 of the preview robot 3. Then, the command generator 413 generates the command to the preview robot 3 on the basis of the reservation information. Specifically, the command generator 413 generates the announcement command for announcing the preview end time (Step ST28).

Then, the command transmitter 414 transmits the announcement command to the preview robot 3 via the Internet 7.

Thereafter, the command receiver 346 of the preview robot 3 receives the announcement command from the management device 4.

Then, the command executor 347 executes the predetermined operation on the basis of the announcement command received by the command receiver 346. Specifically, the command executor 347 displays information that “i minutes remaining until the preview end time” on the display screen of the touch panel 32, and announces the preview end time to the previewer (Step ST29). Thereafter, the preview robot 3 and the management device 4 end the extension announcement processing.

Note that as a means that announces the preview end time to the previewer, for example, an alarm may be sounded to announce to the previewer, or the preview end time may be announced to the previewer by gradually dimming lighting of the room 20, in addition to announcing the preview end time on the display screen of the touch panel 32.

Warning Processing

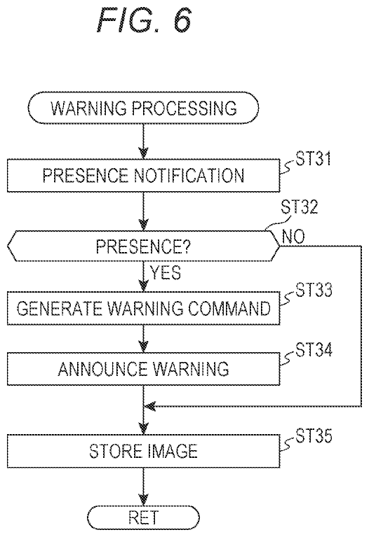

FIG. 6 is a flowchart illustrating a warning processing.

The control unit 41 of the management device 4 executes the warning processing of Steps ST31 to ST35 as illustrated in FIG. 6 according to the predetermined program stored in the memory.

In the warning processing, when the presence of the previewer is detected by the presence detection unit 33, the presence notifier 349 of the preview robot 3 notifies the management device 4 of the presence of the previewer via the Internet 7 (Step ST31).

When the management device 4 is notified of the presence of the previewer via the Internet 7 in Step ST31, the presence manager 416 of the management device 4 causes the storage 417 to store the presence information of the previewer notified by the presence notifier 349, and manages the presence information.

Then, the control unit 41 of the management device 4 determines whether the previewer is present in the room 20 after the preview end time on the basis of the presence information stored in the storage 417 (Step ST32).

When it is determined in Step S32 that the previewer is present in the room 20 after the preview end time, the command generator 413 generates the command to the preview robot 3 on the basis of the reservation information. Specifically, the command generator 413 generates the warning command for announcing the warning to the previewer (Step ST33).

Then, the command transmitter 414 transmits the warning command to the preview robot 3 via the Internet 7.

Thereafter, the command receiver 346 of the preview robot 3 receives the warning command from the management device 4.

Then, the command executor 347 executes the predetermined operation on the basis of the warning command received by the command receiver 346. Specifically, the command executor 347 displays information that “the preview end time has passed” on the display screen of the touch panel 32 to announce to the previewer that the preview end time has passed (Step ST34). Further, the command executor 347 captures the image of the inside of the room 20 by the image capturing unit 31 and stores it in the storage 350 (Step ST35). Thereafter, the preview robot 3 and the management device 4 end the extension announcement processing.

According to such an embodiment, the following operations and effects can be obtained.

(1) Since the preview robot 3 is configured to be placeable inside the building 2 and has portability, it can be placed in the building 2 desired for the preview before the preview, and when the tenant contract is concluded, the preview robot 3 can be easily removed.

(2) The control unit 34 includes the abnormality notifier 341 that notifies the management device 4 of the abnormality via the Internet 7 when the abnormality having occurred inside the building 2 is detected, and the control unit 41 includes the abnormality annunciator 411 that announces the abnormality to the administrator when it is notified of the abnormality by the abnormality notifier 341, so that the manager can easily grasp the abnormality such as damage inside the building 2 even when the building 2 is previewed without the presence of the agent. Therefore, according to the unmanned preview system 1, it is possible to preview the building 2 unattended without requiring the presence of the agent, and to suppress the damage or the like inside the building 2.

(3) The control unit 34 includes the locking device determiner 342 that determines whether the locking device 22 has been normally unlocked, and detects the abnormality having occurred inside the building 2 when it has determined that the locking device 22 has not been normally unlocked, so that for example, unlike the previewer who can unlock the locking device 22 normally, that is, the previewer authorized by the administrator, intrusion of an unauthorized person using an illegal means such as picking can be detected as the abnormality by the locking device determiner 342, and safety of the building 2 can be improved.

(4) The control unit 34 includes the customer service executor 343 that executes customer service by the touch panel 32 when the locking device determiner 342 determines that the locking device 22 is normally unlocked, so that it is possible to execute customer service by the touch panel 32 to the previewer who can unlock the locking device 22 normally, that is, the previewer authorized by the administrator.

(5) The control unit 34 includes the behavior pattern determiner 345 that compares the sample of the normal behavior pattern of the previewer of the building 2 with the behavior pattern obtained by the behavior pattern obtainer and determines whether there is a difference, and detects the abnormality having occurred inside the building 2 when it has determined that there is a difference, so that it is possible to detect by the behavior pattern determiner 345 as the abnormality an intruder with a suspicious behavior pattern such as looking for the inside of the building 2, and to improve the safety of the building 2.

(6) The control unit 34 includes the command receiver 346 that receives the command from the command transmitter 414, and the command executor 347 that executes the predetermined operation on the basis of the command received by the command receiver 346, so that it is possible to reach out to the previewer who is looking around the inside of the building 2 by executing an operation based on an appropriate command.

(7) Since the command executor 347 announces the preview end time to the previewer on the basis of the announcement command, the preview robot 3 can suppress time excess of the preview by announcing the preview end time to the previewer, set free time until reservation of a next previewer to be short, and improve efficiency of previewing the building 2.

(8) Since the command executor 347 announces to the previewer whether the preview time can be extended on the basis of the extension command, when there is free time in the reservation after the preview end time, it is possible to announce to the previewer that the preview time can be extended. In addition, when there is no free time in the reservation after the preview end time, it is possible to announce to the previewer that the preview time cannot be extended.

(9) The control unit 41 includes the application receiver 415 that receives the application for extension transmitted from the application transmitter 348, and the reservation manager 412 changes the preview end time and updates the reservation information on the basis of the application for extension received by the application receiver 415, so that the extension processing can be executed on the basis of the application for extension by the previewer.

(10) The command generator 413 generates the warning command to announce the warning to the previewer when the previewer is present even after the preview end time on the basis of the reservation information and the presence information, and the command executor 347 announces to the previewer that the preview end time has passed on the basis of the warning command, so that it is possible to reliably announce the time excess of the preview to the previewer.

Alternative Implementations

The present invention is not limited to the above-described embodiment, and modifications, improvements, and the like within a range in which an object of the present invention can be achieved are included in the present invention.

For example, in the above embodiment, various functions of the unmanned preview system 1 are distributed and implemented in the preview robot 3 and the management device 4, but any function may be distributed and implemented in either the preview robot 3 or the management device 4, and the unmanned preview system 1 may be appropriately designed as long as the various functions of the unmanned viewing system 1 can be implemented. For example, in the above embodiment, the locking device 22 is connected to the preview robot 3 via the Internet 7, but may be connected to the management device 4 via the Internet 7. In this case, the locking device determiner is only required to be implemented in the management device 4.

In the above embodiment, the management device 4 may be configured by a centralized management type server device or may be a distributed management type, for example, a device using a distributed transaction ledger typified by blockchain can be used, and any device that can manage the reservation information, send various commands to the preview robot 3, and receive and process the application from the preview robot 3 can be used.

Further, in the above embodiment, the management device 4 and the reservation site 6 are separately provided and connected to each other via the Internet 7, but the present invention is not limited to this, and the management device 4 and the reservation site 6 may be provided in a single site, or functions of the management device 4 and the reservation site 6 may be implemented by a plurality of devices distributed on the Internet 7.

In the above embodiment, the control unit 34 includes the behavior pattern determiner 345 that compares the sample of the normal behavior pattern of the previewer of the building 2 with the behavior pattern obtained by the behavior pattern obtainer and determines whether there is a difference, and detects the abnormality having occurred inside the building 2 when it has determined that there is a difference. On the other hand, for example, the transportable device side control unit may include the behavior pattern determiner that compares a sample of an abnormal behavior pattern of the previewer of the building with the behavior pattern obtained by the behavior pattern obtainer and determines whether the sample of a behavior pattern and the obtained behavior pattern match, and detects the abnormality having occurred inside the building when it has determined that the sample of a behavior pattern and the obtained behavior pattern match. In this case, the storage is only required to store as the abnormal behavior pattern the suspicious behavior pattern such as looking for the inside of the building.

In the above embodiment, the command generator 413 generates the extension command that announces whether the preview time can be extended according to the reservation status of the room 20, and the command executor 347 of the preview robot 3 announces to the previewer whether the preview time can be extended, but a function of announcing whether the preview time can be extended can be omitted. Further, in the above embodiment, the preview robot 3 includes the touch panel 32 that receives the input of the application for extension from the previewer, and the application transmitter 348 that transmits the application for extension to the management device 4, and the management device 4 includes the application receiver 415 that receives the application for extension, but functions of inputting and transmitting and receiving such an application for extension can be omitted. Further, the functions related to the announcement and the application for extension may be executed by using the terminal device 5 of the previewer via the reservation site 6.

In the above embodiment, the command generator 413 generates the warning command for announcing the warning to the previewer when the previewer is present even after the preview end time, and the command executor 347 of the preview robot 3 announces the previewer that the preview end time has passed, but the function of announcing such a time excess can be omitted. Further, the function of announcing the time excess may be executed by using the terminal device 5 of the previewer via the reservation site 6.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. An unmanned preview system comprising:
a transportable device that is configured to be placeable inside a building and has portability; and
a management device that is connected to the transportable device via a communication line and manages the transportable device, wherein
the transportable device comprises a transportable device side control means that controls the transportable device,
the transportable device side control means comprises an abnormality notifier that notifies the management device of an abnormality via the communication line when the abnormality having occurred inside the building is detected,
the management device comprises a management device side control means that controls the management device, and
the management device side control means comprises an abnormality annunciator that announces the abnormality to an administrator when the management device side control means is notified of by the abnormality notifier.

2. The unmanned preview system according to claim 1, wherein
the transportable device is connected to a locking device of the building via a communication line, and
the transportable device side control means comprises a locking device determiner that determines whether the locking device has been normally unlocked, and detects the abnormality having occurred inside the building when it has determined that the locking device has not been normally unlocked.

3. The unmanned preview system according to claim 2, wherein
the transportable device comprises a customer service means that serves a previewer of the building, and
the transportable device side control means comprises a customer service executor that executes customer service by the customer service means when the locking device determiner determines that the locking device is normally unlocked.

4. The unmanned preview system according to claim 1, wherein
the transportable device comprises an image capturing means that captures an image of an inside of the building, and
the transportable device side control means comprises:
a storage that stores a sample of a normal behavior pattern of a previewer of the building;
a behavior pattern obtainer that obtains the behavior pattern of the previewer of the building on the basis of the image captured by the image capturing means; and
a behavior pattern determiner that compares a sample of a behavior pattern stored in the storage with the behavior pattern obtained by the behavior pattern obtainer and determines whether there is a difference, and detects the abnormality having occurred inside the building when it has determined that there is the difference.

5. The unmanned preview system according to claim 1, wherein
the transportable device comprises an image capturing means that captures an image of an inside of the building, and
the transportable device side control means comprises:
a storage that stores a sample of an abnormal behavior pattern of a previewer of the building;
a behavior pattern obtainer that obtains the behavior pattern of the previewer of the building on the basis of the image captured by the image capturing means; and
a behavior pattern determiner that compares a sample of a behavior pattern stored in the storage with the behavior pattern obtained by the behavior pattern obtainer and determines whether the samples of a behavior pattern and the obtained behavior pattern match, and detects the abnormality having occurred inside the building when it has determined that the samples of a behavior pattern and the obtained behavior pattern match.

6. The unmanned preview system according to claim 1, wherein
the management device side control means comprises:
a reservation manager that manages reservation information including preview start time and preview end time set by reservation;
a command generator that generates a command to the transportable device on the basis of the reservation information; and
a command transmitter that transmits the command to the transportable device via the communication line, and
the transportable device side control means comprises:
a command receiver that receives the command from the command transmitter; and
a command executor that executes a predetermined operation on the basis of the command received by the command receiver.

7. The unmanned preview system according to claim 6, wherein
the command generator generates an announcement command to announce the preview end time on the basis of the reservation information, and
the command executor announces the preview end time to a previewer on the basis of the announcement command.

8. The unmanned preview system according to claim 6, wherein
the reservation manager manages the reservation information including a reservation status after the preview end time,
the command generator generates an extension command to announce whether a preview time can be extended according to the reservation status on the basis of the reservation information, and
the command executor announces to a previewer whether the preview time can be extended on the basis of the extension command.

9. The unmanned preview system according to claim 8, wherein
the transportable device comprises an input receiving means that receives input of an application for extension by a previewer,
the transportable device side control means comprises an application transmitter that transmits the application for extension to the management device via the communication line when the input of the application for extension is received by the input receiving means,
the management device side control means comprises an application receiver that receives the application for extension transmitted from the application transmitter, and
the reservation manager changes the preview end time and updates the reservation information on the basis of the application for extension received by the application receiver.

10. The unmanned preview system according to claim 6, wherein
the transportable device comprises a presence detection means that detects presence of a previewer inside the building,
the transportable device side control means comprises a presence notifier that notifies the management device of the presence of the previewer via the communication line when the presence detection means detects the presence of the previewer,
the management device side control means comprises a presence manager that manages presence information of the previewer notified by the presence notifier,
the command generator generates a warning command to announce a warning to the previewer when the previewer is present even after the preview end time on the basis of the reservation information and the presence information, and
the command executor announces to the previewer that the preview end time has passed on the basis of the warning command.
